(19) United States
(12) Patent Application Publication
(10) Pub. No.: US 2026/0344701 A1
(43) Pub. Date: Nov. 5, 2026

(54) TEXTURIZED VEGETABLE PROTEIN AND USE THEREOF

(71) Applicant: COSUCRA GROUPE WARCOING S.A., Warcoing (BE)

(72) Inventors: Julie PIHEN, Leers (FR); Ludivine GUIOT, Maulde (FR); Cécile BEAUCARNE, Leers-Nord (BE); Cécilia AUTRAN, La Madeleine (FR)

(73) Assignee: COSUCRA GROUPE WARCOING S.A., Warcoing (BE)

(21) Appl. No.: 19/110,610

(22) PCT Filed: Oct. 11, 2023
(86) PCT No.: PCT/EP2023/078223

§ 371 Date: Mar. 11, 2025

(30) Foreign Application Priority Data
Oct. 11, 2022 (EP) 22200862.5

(51) Int. Cl. A23J 3/22; A23J 3/14; A23J 3/26; A23L 13/40

(52) U.S. Cl. CPC A23J 3/227; A23J 3/14; A23J 3/26; A23L 13/426

(57) ABSTRACT

The invention concerns a texturized vegetable protein (TVP) comprising faba bean protein and pea protein, wherein the texturized vegetable protein comprises at least 60% by weight of pea protein and faba bean protein based on dry weight of the TVP, and wherein the TVP has a hydration capacity of at least 4.0 g water/g of the TVP after a hydration time of 15 minutes. The invention further provides an edible composition comprising the texturized vegetable protein, and the use of the texturized vegetable protein in a food product or a feed product.

### FIELD OF THE INVENTION

The invention is broadly in the field of the plant-based savoury market, more precisely in the field of texturized vegetable protein. In particular, the invention concerns a texturized vegetable protein comprising protein from at least two different types of pulses, and its use in food applications.

### BACKGROUND OF THE INVENTION

Nowadays, two types of texturized protein exist on the market: texturized or textured vegetable protein (TVP) and high moisture meat analogues (HMMA). Generally, TVP has a water content of less than 10% by weight of the product, while the water content of a HMMA is at least 10% by weight of the product.

It is estimated that the European market supply of TVP will at least double in the next five years from 5000 tons to 11000 tons.

TVP protein has prime importance in food industry as well as from a health point of view. Indeed, TVP is used to replace the meat because the texture provided by the TVP can mimic the texture of the meat. TVP is also cholesterol free and used worldwide due to quality protein of plant source. Its utilization is also related with cultural and economic issues, it is especially popular in vegetarians. Worldwide relief agencies use this product in child school nutrition programmes. It is easy to handle, has a larger shelf-life than real meat and has health benefits.

TVP is generally used to completely replace meat in a food serving or it can be eaten in combination with meat as extenders. TVP resembles meat in terms of texture and taste. Animal protein is expensive and in short supply on worldwide basis. Hence, there is a need to replace animal protein. This can be done by utilizing concentrated or isolated plant proteins. Although most vegetable proteins are of inferior quality to animal protein, legumes are good sources of protein, more specifically pulse proteins.

Today, due to increasing consumer demand for healthy diets, and concerns about rising meat prices and environmental issues, plant protein-based food materials are getting of prime importance as meat alternatives worldwide. This is the reason why various types of plant protein-based meat products are now seen in the market like TVP comprising pea protein, faba bean protein, or lentil protein. However, TVP comprising pea protein, faba bean protein, or lentil protein is not satisfactory to replace meat in all kinds of food applications due to unacceptable sensory evaluation including taste and texture.

A recent development is the production of texturized vegetable protein comprising a combination of pea protein and faba bean protein which can replace meat in certain food applications. For instance, due to the low hydration capacity, existing faba bean/pea TVP has high functionality in vegetarian chorizo that requires chunks to mimic fat inclusion, in vegetarian burgers that require good texture to form the patties, or in plant-based Teewurst that requires meat-like texture. However, when used in some other food applications, the functionality of the existing faba bean/pea TVP is not comparable to market standard TVP such as TVP containing pea protein. Therefore, there remains a need in the art for further and/or improved texturized vegetable protein products having different properties than existing TVP products in term of texture, sensory properties, and nutritional value.

### SUMMARY OF THE INVENTION

The present inventors have found a texturized vegetable protein (TVP) comprising faba bean protein and pea protein, thereby addressing one or more of the above-mentioned problems in the art.

Accordingly, a first aspect of the invention relates to a texturized vegetable protein comprising faba bean protein and pea protein, wherein the texturized vegetable protein comprises at least 60% by weight of faba bean protein and pea protein, with % by weight based on dry weight of the texturized vegetable protein, and wherein the texturized vegetable protein has a hydration capacity above (i.e., of more than) 3.0 g water/g of the texturized vegetable protein. Preferably, the texturized vegetable protein comprises faba bean protein concentrate, pea protein concentrate, and pea protein isolate.

Preferably, the invention provides a texturized vegetable protein (TVP) comprising faba bean protein and pea protein, wherein the TVP comprises at least 60% by weight of faba bean protein and pea protein, with % by weight based on dry weight of the TVP, and wherein the TVP has a hydration capacity of at least 4.0 g water/g of the TVP after a hydration time of the TVP of 15 minutes.

As shown in the experimental section, the present inventors found that the present texturized vegetable protein provides good results in terms of texture and taste for food applications. The present texturized vegetable protein has a neutral taste in combination with a hydration capacity comparable to market standard TVP, thereby providing excellent functionality in food applications. Furthermore, the present texturized vegetable proteins are gluten-free, free from animal-based protein, high in essential amino acids, and suitable for vegetarian and vegan products.

Preferably, the texturized vegetable protein has a hydration capacity of from 3.2 to 5.0 g water/g of the texturized vegetable protein; preferably a hydration capacity of from 3.5 to 4.5 g water/g or from 4.0 to 4.5 g water/g of the texturized vegetable protein. Preferably, the texturized vegetable protein has a hydration capacity of from 4.0 to 5.0 g water/g, or from 4.0 to 4.5 g water/g of the texturized vegetable protein after a hydration time of the TVP of 15 minutes. The present texturized vegetable protein has a hydration capacity comparable to market standard TVP, thereby leading to advantageous functionalities in food and feed applications.

Accordingly, a further aspect of the invention provides an edible composition comprising the texturized vegetable protein as defined herein; preferably wherein the edible composition is a food or feed product; more preferably wherein the edible composition is a vegetarian product, vegan product, meat product, dairy product, non-dairy product, confectionery product, beverage, food supplement, nutritional product destined to weight control, sports food, medical food, food for elderly, or bakery food product.

A further aspect of the invention provides the use of the texturized vegetable protein as defined herein, in a food product or a feed product; preferably in vegetarian products, vegan products, meat products, dairy products, non-dairy products, confectionery products, beverages, food supplements, nutritional products destined to weight control, sports food, medical food, food for elderly, or bakery food products; more preferably as a meat analogue or a meat extender. The texturized vegetable protein can advantageously be used as a meat analogue or meat extender.

The above and further aspects and preferred embodiments of the invention are described in the following sections and in the appended claims. The subject-matter of appended claims is hereby specifically incorporated in this specification.

### DETAILED DESCRIPTION OF THE INVENTION

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms also encompass “consisting of” and “consisting essentially of”.

The recitation of numerical ranges by endpoints includes all numbers and fractions subsumed within the respective ranges, as well as the recited endpoints.

The term “about” as used herein when referring to a measurable value such as a parameter, an amount, a temporal duration, and the like, is meant to encompass variations of and from the specified value, in particular variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

Whereas the term “one or more”, such as one or more members of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

All documents cited in the present specification are hereby incorporated by reference in their entirety.

Unless otherwise specified, all terms used in disclosing the invention, including technical and scientific terms, have the meaning as commonly understood by one of ordinary skill in the art to which this invention belongs. By means of further guidance, term definitions may be included to better appreciate the teaching of the present invention.

By experimental testing, the present inventors have found texturized vegetable protein with pleasant taste and good texture, and excellent functionalities in food applications.

Accordingly, the present invention relates to a texturized vegetable protein (TVP) comprising faba bean protein and pea protein, wherein the texturized vegetable protein has a protein content of at least 60% by weight based on dry weight of the TVP, and wherein the TVP has a hydration capacity above 3.0 g water/g of the TVP.

Preferably, the invention relates to a texturized vegetable protein (TVP) comprising faba bean protein and pea protein, wherein the texturized vegetable protein has a protein content of at least 60% by weight based on dry weight of the TVP, and wherein the TVP has a hydration capacity of at least 4.0 g water/g of the TVP after a hydration time of 15 minutes.

The terms “textured vegetable protein”, “texturized vegetable protein”, “texturized plant protein”, or “TVP” may be used interchangeably herein and refers to a plant-based protein product prepared by extrusion.

In embodiments, a TVP is a dry product. In embodiments, a TVP has a water content of less than 10% by weight, with % by weight based on the total weight of the TVP. In embodiments, a TVP has a water content of less than 8% by weight, less than 6% by weight, less than 5% by weight, less than 4% by weight, less than 3% by weight, less than 2% by weight, or less than 1% by weight. This is as opposed to a high moisture meat analogue (HMMA) having a water content of at least 10% by weight. The water content as used herein refers to the water content of the product after extrusion and before performing any further processing step on the product such as a drying step. For instance, when a product is dried after extrusion to lower the water content, the water content should be determined prior to the drying step. Preferably, the water content as used herein refers to the water content of the product as measured immediately (e.g., at most 6 hours, at most 1 hour, at most 30 minutes, at most 20 minutes, at most 15 minutes, at most 10 minutes, at most 5 minutes, or at most 1 minute) after extrusion of the product.

In embodiments, a TVP is an expanded or air expanded product. In embodiments, a TVP is an extruded and (air) expanded product. In embodiments, a TVP is a dry, extruded, and (air) expanded product. In embodiments, a TVP is an expanded or air expanded plant-based protein product. In embodiments, a TVP is an extruded and (air) expanded plant-based protein product. In embodiments, a TVP is a dry, extruded, and (air) expanded plant-based protein product.

In embodiments, the TVP may be a texturized pulse protein.

As used herein, the term “pulse” refers to dried seeds of legume. There are 11 types of pulses: dry beans, dry broad beans, dry peas, chickpeas, cow peas, pigeon peas, lentils, Bambara beans, vetches, lupins and pulses nes (minor pulses).

The term “legume” refers to a plant in the family Fabaceae (or Leguminosae), or the fruit or seed of such a plant.

Dry beans (Phaseolus spp. including several species in Vigna) are selected from the group consisting of Adzuki Beans, Anasazi Beans, Appaloosa Beans, Baby Lima Beans, Black Calypso Beans, Black Turtle Beans, Dark Red Kidney Beans, Great Northern Beans, Jacob's Cattle Trout Beans, Large Faba Beans, Large Lima Beans, Mung Beans, Pink Beans, Pinto Beans, Romano Beans, Scarlet Runner Beans, Tongue of Fire, White Kidney Beans and White Navy Beans.

Dry peas (Pisum spp.) are selected from garden pea (Pisum sativum var. sativum) and protein pea (Pisum sativum var. arvense). Dry peas are represented by: Black-Eyed Peas, Green Peas, Marrowfat Peas, Pigeon Peas, Yellow Peas and Yellow-Eyed Peas.

Chickpeas or chick peas (Cicer arietinum) are selected from gram or Bengal gram, garbanzo or garbanzo bean (kabuli), or Egyptian pea.

Lentils (Lens Culinaris) are selected from Beluga Lentils, Brown Lentils, French Green Lentils, Green Lentils, or Red Lentils.

In embodiments, the TVP may have a solids content of at least 88% by weight, with % by weight based on the total weight of the TVP. In embodiments, the TVP may have a solids content of at least 89% by weight, at least 90% by weight, at least 91% by weight, at least 92% by weight, at least 93% by weight, at least 94% by weight, or at least 95% by weight. In embodiments, the solids content of the TVP as taught herein may be from about 90% by weight to about 95% by weight. Preferably, the TVP has a solids content of at least 90% by weight, with % by weight based on the total weight of the TVP.

The terms “% by weight”, “percentage by mass”, “percentage by weight” or “wt %” may be used interchangeably herein and refer to the mass fraction w; times 100. The mass fraction wᵢ is the ratio of the mass mᵢ of one compound to the mass mₜₒₜ of the total mixture (e.g., the TVP as taught herein), as defined in (1):

$${w}_{i} = \frac{{m}_{i}}{{m}_{t o t}} \qquad ( 1 )$$

The terms “solids content” or “dry matter content” may be used interchangeably herein and refer to the ratio of the weight of solids in a composition to the total weight of the composition. The solids content may be expressed as a ratio of the weight of a sample after drying (in g) to the weight of a sample before drying (in g). For instance, the solids content may be expressed as a weight percentage (wt %) or g of dry matter per 100 g of sample. The solids content may be determined gravimetrically. Moisture may be evaporated from the sample by oven drying.

The terms “composition”, “formulation”, or “preparation” may be used interchangeably herein and refer to a mixture of ingredients.

In embodiments, the TVP comprises, consists essentially of, or consists of faba bean protein and pea protein.

As used herein, the terms “faba bean”, “fava bean” or “broad bean” refer to the seeds contained in the pod of Vicia faba and its subspecies, varieties or cultivars. Varieties that are fed to horses or other animals are called field bean, tic bean, tick bean, or horse bean (Vicia faba var. equina). Other varieties include Vicia faba var. major, with large seeds, and Vicia faba var. minor, with small seeds. “Faba bean protein” or “faba protein” as used herein refers to the proteins contained in the faba bean seeds. Faba bean protein may include several classes of protein: albumins, globulins, glutelins, and prolamins.

As used herein, the term “pea” refers to the round seeds contained in the pod of Pisum sativum and its subspecies, varieties or cultivars. Preferably, the peas are yellow peas, preferably dry yellow peas, i.e. yellow peas which have been harvested in a dry state. “Pea protein” as used herein therefore refers to the proteins contained in the pea seeds. Pea protein may include several classes of protein: globulins, albumins, prolamins, and glutelins.

In embodiments of the products or uses as taught herein, the TVP comprises at least 60% by weight of proteins, in particular faba bean protein and pea protein, with % by weight based on dry weight of the TVP. In embodiments, the TVP comprises (based on dry matter) at least 61% by weight, at least 62% by weight, at least 63% by weight, or at least 64% by weight of proteins, in particular faba bean protein and pea protein. In embodiments, the TVP comprises (based on dry matter) at least 65% by weight, at least 66% by weight, at least 67% by weight, at least 68% by weight, at least 69% by weight, or at least 70% by weight of proteins, such as at least 75% by weight or at least 80% by weight of proteins, in particular faba bean protein and pea protein. In embodiments, the TVP comprises (based on dry matter) from 60% by weight to 80% by weight of proteins, in particular faba bean protein and pea protein. Preferably, the TVP comprises (based on dry matter) from 60% by weight to 70% by weight, such as from 60% by weight to 65% by weight or from 65% by weight to 70% by weight of proteins, in particular faba bean protein and pea protein.

The protein, such as the pea protein and/or faba bean protein, may be determined by measuring the protein content. The “protein content” refers to the ratio of the weight of proteins in a composition (based on dry matter) to the total weight of the composition (based on dry matter). The protein content may be expressed as 6.25 times the ratio of the weight of nitrogen after combustion (in g) to the weight of a sample before combustion (in g). For instance, the protein content may be expressed as a percentage (%) protein=6.25×nitrogen percentage (% nitrogen)=6.25×g of nitrogen per 100 g of sample. Unless indicated otherwise, % by weight of proteins as used herein is expressed based on dry weight of the TVP.

The protein content may be determined by any known method for determining protein concentration such as by the Dumas method or Kjeldahl method.

In embodiments, the texturized vegetable protein may comprise, consist essentially of, or consist of faba bean protein concentrate, pea protein concentrate, and pea protein isolate. In embodiments, the texturized vegetable protein may be prepared by extruding a mixture comprising, consisting essentially of, or consisting of faba bean protein concentrate, pea protein concentrate, and pea protein isolate. In embodiments, the texturized vegetable protein may be prepared by extruding a mixture comprising, consisting essentially of, or consisting of from 25% to 45% by weight of faba bean protein concentrate, from 15% to 40% by weight of pea protein concentrate, and from 25% to 50% by weight of pea protein isolate, with % by weight based on dry weight of the mixture.

Protein extraction from pulse flour (e.g. pea flour or faba bean flour) yields either protein concentrate or protein isolate. Generally, protein concentrates are prepared using dry or wet processing methods, whereas protein isolates derive solely from wet processes.

The term “protein concentrate” as used herein refers to a mixture of protein, starch, and fibers obtained from pulse seeds. A protein concentrate may further comprise sugars and flavour components.

The term “protein isolate” as used herein refers to a mixture obtained from pulse seeds, the mixture comprising protein but no fibers.

Accordingly, the amount of fibers in the TVP may be indicative of the amount of protein concentrate (e.g. pea protein concentrate and/or faba bean protein concentrate) in the TVP.

In embodiments, the faba bean protein may be faba bean protein concentrate.

The term “faba bean protein concentrate” refers to a mixture of protein, starch, and fibers obtained from the faba bean seeds. Methods for obtaining a faba bean protein concentrate are known in the art. Faba bean protein concentrates are typically produced using air classification, which separates beans into fractions based on different particle sizes. Air currents fed into a classifying chamber separate flour based on centrifugal and gravitational forces as a function of size and density, which then generates two main fractions: a fine protein-rich and a coarse starch-rich fraction (Lundgren, 2011, Uppsala, Sweden: SLU, Dept. of Food Science). Electrostatic separation is another dry extraction method relying on differences in dielectric properties of particles instead of their size and density (Sharan et al., 2021, Compr Rev Food Sci Food Saf.; 20:401-428).

In embodiments, the faba bean protein concentrate may comprise at least 50% by weight of proteins (based on dry matter). In embodiments, the faba bean protein concentrate may comprise (at least 55% by weight of proteins (based on dry matter). In embodiments, the faba bean protein concentrate may comprise at least 60% by weight of proteins (based on dry matter). In embodiments, the faba bean protein concentrate may comprise at least 65% by weight of proteins (based on dry matter).

In embodiments, the faba bean protein concentrate comprises (based on dry matter) from 50 wt % to 80 wt % of proteins, preferably from 55 wt % to 80 wt % of proteins, more preferably from 60 wt % to 80 wt % of proteins, more preferably from 65 wt % to 80 wt % of proteins. In embodiments, the faba bean protein concentrate may comprise (based on dry matter) from 60 wt % to 70 wt % of proteins.

Examples of commercially available faba bean protein concentrate include HerbaPRO FB65-010 (Herba Ingredients BV, The Netherlands), and VITESSENCE® Pulse 3600 faba bean protein concentrate (Ingredion, Germany).

In embodiments, the pea protein may be pea protein concentrate, pea protein isolate, or a combination thereof. Preferably, the pea protein is pea protein concentrate and pea protein isolate. The term “pea protein isolate” refers to a pea protein extract or a composition comprising (based on dry matter) at least 80 wt % proteins, preferably at least 81 wt % proteins, more preferably at least 85 wt %. Preferably, the term pea protein isolate refers to a composition comprising (based on dry matter) from 80 wt % to 98 wt % of proteins, preferably from 81 wt % to 98 wt % of proteins, more preferably from 85 wt % to 98 wt % of proteins, more preferably from 88 wt % to 98 wt % of proteins. The skilled person will understand that when referring to “pea protein isolate” in some embodiments, in fact a composition is described, which predominantly, but not exclusively comprises pea proteins. Residual impurities may be present in such compositions. Such residual impurities may include for instance minerals, sugars, etc. Methods for obtaining a pea protein isolate are known in the art. Such methods involve extracting and purifying proteins from peas. Isolating pea proteins comprises at least one step selected from precipitation, flocculation, filtration, chromatography, and/or concentration, as described in WO2015/071498.

In embodiments, the pea protein isolate may comprise at least 81% by weight of proteins (based on dry matter). In embodiments, the pea protein isolate may comprise at least 85% by weight of proteins (based on dry matter). In embodiments, the pea protein isolate may comprise at least 90% by weight of proteins (based on dry matter).

In embodiments, the pea protein isolate may comprise (based on dry matter) from 81 wt % to 99 wt % of proteins, preferably from 81 wt % to 98 wt % of proteins, more preferably from 85 wt % to 98 wt % of proteins, more preferably from 90 wt % to 98 wt % of proteins. In embodiments, the pea protein concentrate may comprise (based on dry matter) from 81 wt % to 98 wt % of proteins. Examples of commercially available pea protein isolates include Pisane (Cosucra Groupe Warcoing, Belgium), and Empro (Emsland, Germany).

The term “pea protein concentrate” refers to a pea product comprising a mixture of protein, starch, and fibers obtained from pea seeds. Methods for obtaining a pea protein concentrate are known in the art, and typically include an air classification step (Swanson, 1990, Journal of the American Oil Chemists' Society, 67, 276-280).

In embodiments, the pea protein concentrate may comprise at least 50% by weight of proteins (based on dry matter). In embodiments, the pea protein concentrate may comprise at least 55% by weight of proteins (based on dry matter). In embodiments, the pea protein concentrate may comprise at least 60% by weight of proteins (based on dry matter).

In embodiments, the pea protein concentrate may comprise (based on dry matter) from 50 wt % to 80 wt % of proteins, preferably from 55 wt % to 80 wt % of proteins, more preferably from 60 wt % to 80 wt % of proteins, more preferably from 65 wt % to 80 wt % of proteins. In embodiments, the pea protein concentrate may comprise (based on dry matter) from 50 wt % to 60 wt % of proteins. Examples of commercially available pea protein concentrate include AMN Pea Protein concentrate (AM Nutrition, Norway), and VITESSENCE® Pulse 1550 yellow pea protein concentrate (Ingredion, Germany).

In embodiments, the texturized vegetable protein may comprise from 25% to 45% by weight of faba bean protein concentrate, from 15% to 40% by weight of pea protein concentrate, and/or from 25% to 50% by weight of pea protein isolate, with % by weight based on dry weight of the TVP. In embodiments, the texturized vegetable protein may comprise from 30% to 40% by weight of faba bean protein concentrate, from 15% to 35% by weight of pea protein concentrate, and/or from 25% to 45% by weight of pea protein isolate, with % by weight based on dry weight of the TVP. In embodiments, the texturized vegetable protein may comprise from 25% to 45% by weight of faba bean protein concentrate, from 15% to 40% by weight of pea protein concentrate, and/or from 25% to 40% by weight of pea protein isolate, with % by weight based on dry weight of the TVP.

In embodiments, the texturized vegetable protein may comprise from 25% to 45% by weight of faba bean protein concentrate comprising from 50 wt % to 80 wt % of proteins, preferably from 55 wt % to 80 wt % of proteins, more preferably from 60 wt % to 80 wt % of proteins, more preferably from 65 wt % to 80 wt % of proteins, such as from 60 wt % to 70 wt % of proteins.

In embodiments, the texturized vegetable protein may comprise from 15% to 40% by weight of pea protein concentrate comprising from 50 wt % to 80 wt % of proteins, preferably from 55 wt % to 80 wt % of proteins, more preferably from 60 wt % to 80 wt % of proteins, more preferably from 65 wt % to 80 wt % of proteins, such as from 50 wt % to 60 wt % of proteins.

In embodiments, the texturized vegetable protein may comprise from 25% to 50% by weight of pea protein isolate comprising from 81 wt % to 99 wt % of proteins, preferably from 81 wt % to 98 wt % of proteins, more preferably from 85 wt % to 98 wt % of proteins, more preferably from 90 wt % to 98 wt % of proteins, such as from 81 wt % to 98 wt % of proteins.

In embodiments, the texturized vegetable protein may comprise from 25% to 45% by weight of faba bean protein concentrate comprising from 50 wt % to 80 wt % of proteins, from 15% to 40% by weight of pea protein concentrate comprising from 50 wt % to 80 wt % of proteins, and from 25% to 50% by weight of pea protein isolate comprising from 81 wt % to 99 wt % of proteins.

In embodiments, the texturized vegetable protein may comprise from 25% to 45% by weight of faba bean protein concentrate comprising from 60 wt % to 70 wt % of proteins, from 15% to 40% by weight of pea protein concentrate comprising from 50 wt % to 60 wt % of proteins, and/or from 25% to 50% by weight of pea protein isolate comprising from 81 wt % to 98 wt % of proteins.

The faba bean protein content of the TVP may be calculated based on the amount of faba bean protein concentrate having a known protein content. In embodiments, the texturized vegetable protein may comprise at least 12.5% by weight of faba bean protein. For instance, the texturized vegetable protein may comprise at least 15% by weight, at least 16% by weight, at least 17% by weight, or at least 18% by weight of faba bean protein. In embodiments, the texturized vegetable protein may comprise from 12.5% to 36% by weight of faba bean protein. In embodiments, the texturized vegetable protein may comprise from 15% to 32% by weight of faba bean protein. In embodiments, the texturized vegetable protein may comprise from 16% to 30% by weight of faba bean protein. In embodiments, the texturized vegetable protein may comprise from 18% to 28% by weight of faba bean protein. Such TVPs advantageously have high protein content and satisfactory nutritional and functional properties.

The pea protein content of the TVP may be calculated based on the amount of pea protein concentrate having a known protein content and/or the amount of pea protein isolate having a known protein content. In embodiments, the texturized vegetable protein may comprise at least 27.75% by weight of pea protein. In embodiments, the texturized vegetable protein may comprise at least 28% by weight, at least 29% by weight, at least 30% by weight, at least 35% by weight, at least 36% by weight, at least 37% by weight, at least 38% by weight, at least 39% by weight, at least 40% by weight, at least 41% by weight, at least 42% by weight, at least 43% by weight, at least 44% by weight, or at least 45% by weight of pea protein. In embodiments, the texturized vegetable protein may comprise from 27.75% to 81.5% by weight of pea protein. In embodiments, the texturized vegetable protein may comprise from 28% to 68% by weight of pea protein. In embodiments, the texturized vegetable protein may comprise from 40% to 55% by weight of pea protein. In embodiments, the texturized vegetable protein may comprise from 41% to 51% by weight of pea protein. Such TVPs advantageously have high protein content and satisfactory nutritional and functional properties.

The protein content of faba bean protein and pea protein of the TVP may be calculated based on the amount of faba bean protein concentrate having a known protein content, the amount of pea protein concentrate having a known protein content, and/or the amount of pea protein isolate having a known protein content. In embodiments, the texturized vegetable protein may comprise at least 12.5% by weight of faba bean protein, e.g. at least 15% by weight, at least 16% by weight, at least 17% by weight, or at least 18% by weight of faba bean protein; and at least 27.75% by weight of pea protein, e.g. at least 28% by weight, at least 29% by weight, at least 30% by weight, at least 35% by weight, at least 36% by weight, at least 37% by weight, at least 38% by weight, at least 39% by weight, at least 40% by weight, at least 41% by weight, at least 42% by weight, at least 43% by weight, at least 44% by weight, or at least 45% by weight of pea protein. In embodiments, the texturized vegetable protein may comprise at least 16% by weight of faba bean protein and at least 40% by weight of pea protein.

In embodiments, the texturized vegetable protein may comprise from 12.5% to 36% by weight of faba bean protein, and/or from 27.75% to 81.5% by weight of pea protein, with % by weight based on dry weight of the TVP. In embodiments, the texturized vegetable protein may comprise from 15% to 32% by weight of faba bean protein, and/or from 28% to 68% by weight of pea protein, with % by weight based on dry weight of the TVP. In embodiments, the texturized vegetable protein may comprise from 16% to 30% by weight of faba bean protein and from 40% to 55% by weight of pea protein, with % by weight based on dry weight of the TVP. In embodiments, the texturized vegetable protein may comprise from 18% to 28% by weight of faba bean protein and from 41% to 51% by weight of pea protein, with % by weight based on dry weight of the TVP. Such TVPs advantageously have high protein content and satisfactory nutritional and functional properties.

In embodiments, the texturized vegetable protein may comprise a ratio (by weight) of pea protein/faba bean protein of 0.67 (i.e. 40/60) to 9 (i.e. 90/10). In embodiments, the TVP may comprise a ratio (by weight) of pea protein/faba bean protein of 0.82 (i.e. 45/55), 1 (i.e. 50/50), 1.22 (i.e. 55/45), 1.5 (i.e. 60/40), 2.33 (i.e. 70/30), 3 (i.e. 75/25), 4 (i.e. 80/20), or 5.67 (i.e. 85/15), or any value lying within this range. Preferably, the TVP may comprise a ratio (by weight) of pea protein/faba bean protein of 0.82 to 5.67, or of 1 to 4, such as a ratio of 1.22 to 3 or of 1.5 to 2.33. In embodiments, the texturized vegetable protein may comprise further pulse protein selected from chickpea protein, bean protein, cow pea protein, pigeon pea protein, lentil protein, Bambara bean protein, vetch protein, lupin protein, pulse nes protein, or a combination thereof. In embodiments, the texturized vegetable protein may comprise further pulse protein selected from chickpea protein, bean protein, or a combination thereof.

The term “chickpea protein” as used herein refers to the proteins contained in the chickpea seeds.

The term “bean protein” as used herein refers to the proteins contained in the bean seeds.

The texturized vegetable protein has a hydration capacity above 3.0 g water/g of the texturized vegetable protein. In embodiments, the TVP may have a hydration capacity of from 3.2 to 5.0 g water/g of the TVP, such as a hydration capacity of from 3.5 to 5.0 g water/g of the TVP, from 3.5 to 4.5 g water/g of the TVP, or from 3.5 to 4.0 g water/g of the TVP. In embodiments, the TVP may have a hydration capacity of at least 3.1 g water/g of the TVP, such as a hydration capacity of at least 3.2 g water/g of the TVP, at least 3.3 g water/g of the TVP, at least 3.4 g water/g of the TVP, at least 3.5 g water/g of the TVP, at least 3.6 g water/g of the TVP, at least 3.7 g water/g of the TVP, at least 3.8 g water/g of the TVP, at least 3.9 g water/g of the TVP, or at least 4.0 g water/g of the TVP. The texturized vegetable protein has a hydration capacity of at least 4.0 g water/g of the texturized vegetable protein after a hydration time of the TVP of 15 minutes. In embodiments, the TVP may have a hydration capacity of from 4.0 to 5.0 g water/g of the TVP, such as a hydration capacity of from 4.0 to 4.5 g water/g of the TVP, from 4.1 to 4.5 g water/g of the TVP, or from 4.2 to 4.5 g water/g of the TVP after a hydration time of the TVP of 15 minutes. In embodiments, the TVP may have a hydration capacity of at least 4.1 g water/g of the TVP, such as a hydration capacity of at least 4.2 g water/g of the TVP, at least 4.3 g water/g of the TVP, at least 4.4 g water/g of the TVP, at least 4.5 g water/g of the TVP, at least 4.6 g water/g of the TVP, at least 4.7 g water/g of the TVP, at least 4.8 g water/g of the TVP, or at least 4.9 g water/g of the TVP after a hydration time of the TVP of 15 minutes. As illustrated in the example section, such TVP provides high functionality, while having satisfactory sensory properties due to the presence of pea protein and faba bean protein.

In embodiments, the TVP may have a hydration capacity of at most 5.0 g water/g of the TVP, such as a hydration capacity of at most 4.8 g water/g of the TVP, at most 4.6 g water/g of the TVP, at most 4.5 g water/g of the TVP, at most 4.4 g water/g of the TVP, at most 4.2 g water/g of the TVP, or at most 4.0 g water/g of the TVP.

The terms “hydration capacity”, “hydration ratio”, “hydration rate”, “water hydration capacity”, “water absorption”, “water uptake”, or “water holding or binding” as used herein refers to the maximum amount of water that 1 g of material will imbibe and retain after 15 minutes. The hydration capacity may be measured by any method suitable for determining the hydration capacity as known in the art such as by putting in a beaker a volume of water with a mass m1 of TVP. The mixture is let for a hydration time of 15 minutes. The TVP is then collected using a sieve and the mass of the TVP is weighted after hydration, noted m2. The hydration capacity is: (m2-m1)/m1. For instance, the hydration capacity may be measured by putting in an 800 ml beaker, 400 ml of water with 15 g of TVP. The mixture is let for a hydration time of 15 minutes. The TVP is then collected using a sieve. The TVP is weighted after hydration, noted P. The hydration rate is: (P −15)/15.

Accordingly, a further aspect relates to a texturized vegetable protein comprising protein from at least two different pulses, wherein the texturized vegetable protein has a hydration capacity above 3.0 g water/g of the texturized vegetable protein. In embodiments, the TVP may have a hydration capacity of from 3.2 to 5.0 g water/g of the TVP, from 3.5 to 5.0 g water/g of the TVP, from 3.5 to 4.5 g water/g of the TVP, or from 3.5 to 4.0 g water/g of the TVP. Preferably, a further aspect relates to a texturized vegetable protein comprising protein from at least two different pulses, wherein the texturized vegetable protein has a hydration capacity of at least 4.0 g water/g of the texturized vegetable protein after a hydration time of 15 minutes. In embodiments, the TVP may have a hydration capacity of from 4.0 to 5.0 g water/g of the TVP, or from 4.0 to 4.5 g water/g of the TVP after a hydration time of 15 minutes. In embodiments, the TVP may comprise (based on dry matter) at least 60% by weight or at least 65% by weight of proteins, such as from 60% by weight to 65% by weight of proteins. In embodiments, the TVP may have a density of 0.030 kg/l to 0.100 kg/l or a density of 0.050 kg/l to 0.080 kg/l. In embodiments, the pulse protein may be selected from the group consisting of the pea protein, faba bean protein, chickpea protein, bean protein, cow pea protein, pigeon pea protein, lentil protein, Bambara bean protein, vetch protein, lupin protein, and pulse nes protein. In embodiments, the pulse protein may be selected from the group consisting of pea protein, faba bean protein, chickpea protein, and bean protein. In embodiments, the pulse protein may be pea protein and faba bean protein. The present inventors have advantageously found that such TVPs having a hydration capacity of above 3.0 g water/g of the TVP, such as from 3.2 to 5.0 g water/g of the TVP, from 3.5 to 5.0 g water/g of the TVP, from 3.5 to 4.5 g water/g of the TVP, or from 3.5 to 4.0 g water/g of the TVP, preferably of at least 4.0 g water/g of the TVP, such as from 4.0 to 5.0 g water/g of the TVP or from 4.0 to 4.5 g water/g of the TVP, provides a TVP with excellent properties namely satisfactory sensory analysis, while providing high functionality in food applications.

In embodiments, the TVP may be free of additives. In embodiments, the TVP may be free of salt, in particular sodium salts. In embodiments, the TVP may be free of additives with the exception of calcium chloride (CaCl₂)).

In embodiments, the TVP may comprise calcium chloride (CaCl₂)). In embodiments, the TVP may comprise at most 5% by weight of calcium chloride based on dry weight of the TVP. For instance, the TVP may comprise at most 4% by weight, at most 3% by weight, at most 2% by weight, at most 1% by weight, or at most 0.5% by weight of calcium chloride, based on dry weight of the TVP. In embodiments, the TVP may comprise from 0.5% by weight to 5% by weight of calcium chloride, such as from 1% by weight to 3% by weight of calcium chloride based on dry weight of the TVP. In embodiments, the TVP may comprise, consist essentially of, or consist of pea protein concentrate, faba bean protein concentrate, pea protein isolate, and optionally calcium chloride (CaCl₂)). In embodiments, the TVP may comprise from 15% to 40% by weight of pea protein concentrate, from 25% to 45% by weight of faba bean protein concentrate, from 30% to 50% by weight of pea protein isolate, and optionally from 0.5% by weight to 5% by weight of calcium chloride, based on dry weight of the TVP.

In embodiments, the texturized vegetable protein may be prepared by extruding a mixture comprising, consisting essentially of, or consisting of faba bean protein concentrate, pea protein concentrate, pea protein isolate, and calcium chloride (CaCl₂)). In embodiments, the texturized vegetable protein may be prepared by extruding a mixture comprising, consisting essentially of, or consisting of from 25% to 45% by weight of faba bean protein concentrate, from 15% to 40% by weight of pea protein concentrate, from 25% to 50% by weight of pea protein isolate, and from 0.5% to 5% by weight of calcium chloride, with % by weight based on dry weight of the mixture.

In embodiments, the TVP may be free of allergens.

In embodiments, the TVP may be free of gluten or seed storage proteins found in cereal grains, such as wheat, barley, rye and oats, as well as any cross hybrids of these grains (such as triticale).

In embodiments, the TVP may be free of any ingredient of animal origin. Hence, the TVP may be suitable for vegetarian and vegan customers. In embodiments, the TVP may be free of protein of animal origin, such as for example egg white or eggs.

In embodiments, the texturized vegetable protein may have a density of 0.030 kg/l (i.e., 30 g/l) to 0.100 kg/l (i.e., 100 g/l). In embodiments, the texturized vegetable protein may have a density of 0.050 kg/l (i.e., 50 g/l) to 0.080 kg/l (i.e., 80 g/l) such as a density of 0.055 kg/l (i.e., 55 g/l) to 0.075 kg/l (i.e., 75 g/l) or 0.060 kg/l (i.e., 60 g/l) to 0.070 kg/l (i.e., 70 g/l).

The term “density” of a substance or composition refers to its mass per unit volume.

The density of the TVP may be determined by any method suitable for determining the density as known in the art. For instance, the density of the TVP may be determined by pouring the TVP in a 500 ml glass and measuring the mass (m), e.g. in g. Volume (Vav) may be recorded in ml. Density was calculated by dividing the mass (e.g. in g or kg) by the volume (e.g. in ml or I).

In embodiments, the texturized vegetable protein may comprise:
particles having a shape of chunks, granules, or slices; and/or
particles having a size (i.e. of the largest dimension) of at most 5.0 cm (50.0 mm), such as at most 4.5 cm (45.0 mm), at most 4.0 cm (40.0 mm), at most 3.5 cm (35.0 mm), at most 3.0 cm (30.0 mm), at most 2.5 cm (25.0 mm), or at most 2.0 cm (20.0 mm); preferably wherein the texturized vegetable protein comprises particles having a size (i.e. the largest dimension) of from 0.5 cm (5.0 mm) to 5.0 cm (50.0 mm), such as from 1.0 cm (10.0 mm) to 4.0 cm (40.0 mm) or from 1.5 cm to 3.5 cm.

In embodiments, the texturized vegetable protein may comprise particles having a shape of chunks, granules, slices, or fine slices. Preferably, the TVP may comprise particles having a shape of chunks. The shape of the TVP may be determined by visual inspection. Chunks refer to particles having a size of 10.0 mm to 50.0 mm; granules refer to particles having a size of less than 10.0 mm; slices refer to particles with the slice having a thickness of more than 1.00 mm (>1.00 mm).

In embodiments, the TVP may comprise particles having a length of at most 5.0 cm, such as at most 4.5 cm, at most 4.0 cm, at most 3.5 cm, at most 3.0 cm, at most 2.5 cm, or at most 2.0 cm; preferably wherein the texturized vegetable protein comprises particles having a length of from 0.5 cm to 5.0 cm, such as from 1.0 cm to 4.0 cm or from 1.0 cm to 3.0 cm.

In embodiments, the TVP may comprise particles having a width of at most 3.0 cm, such as at most 2.5 cm, or at most 2.0 cm; preferably wherein the texturized vegetable protein comprises particles having a width of from 0.5 cm to 3.0 cm, such as from 1.0 cm to 2.0 cm.

A further aspect relates to an edible composition comprising the texturized vegetable protein as defined herein or prepared by the method as defined herein. Accordingly, a further aspect relates to an edible composition comprising a TVP, wherein the TVP comprises at least 60% by weight of faba bean protein and pea protein, with % by weight based on dry weight of the TVP, and wherein the TVP has a hydration capacity above 3.0 g water/g of the TVP. Preferably, the TVP comprises faba bean protein concentrate, pea protein concentrate, and pea protein isolate.

As used herein, and as will be understood by the person skilled in the art, an “edible” composition refers to a composition which is suitable for human or animal consumption. Preferably the edible composition is a food or feed product; more preferably the edible composition is a vegetarian product, vegan product, meat product, dairy product, non-dairy product, confectionery product, beverage, food supplement, nutritional product destined to weight control, sports food, medical food, food for elderly, or bakery food product.

The term “vegetarian product” as used herein refers to any food that excludes meat and animal tissue products (such as gelatine).

The term “vegan product” or “plant-based product” as used herein refers to any food that excludes all animal products (e.g. excluding meat, dairy, eggs, honey, and any other animal-derived substances).

Accordingly, in a further aspect, the invention relates to the use of the texturized vegetable protein as defined herein or prepared by the method as defined herein, in a food product or a feed product; preferably in vegetarian products, vegan products, meat products, dairy products, non-dairy products, confectionery products, beverages, food supplements, nutritional products destined to weight control, sports food, medical food, food for elderly, or bakery food products; more preferably as a meat analogue or a meat extender. The TVPs as taught herein may for instance partially or completely replace other proteins in food or feed products, such as for instance proteins of animal origin. Particularly suited applications of the TVPs as taught herein may for instance involve applications in which the complete or partial replacement of meat or animal-based protein is desired, for instance in plant-based meat.

In embodiments, the texturized vegetable protein as taught herein may be used as a meat analogue or a meat extender.

The terms “meat analogue” or “meat substitute” refers to a meat-like substance made from vegetarian or vegan ingredients.

The term “meat extender” refers to any non-meat substance with substantial protein content (as opposed to a “filler”).

A further aspect relates to a method for preparing a TVP, preferably a TVP as defined herein, the method comprising:
extruding a mixture comprising faba bean protein and pea protein, wherein at least 60% by weight of faba bean protein and pea protein, with % by weight based on dry weight of the mixture, are extruded in an extruder comprising at least three consecutive heating zones, wherein the temperature of a first consecutive heating zone is about 45 °C to about 55 °C, the temperature of a second consecutive heating zone is about 91 °C to about 100 °C, and the temperature of a third consecutive heating zone is about 101 °C to about 110 °C, thereby obtaining an extruded protein mixture, and
passing the extruded protein mixture through a die, thereby obtaining the texturized vegetable protein.

The present method advantageously allows to prepare a TVP having satisfactory nutritional and functional properties for food applications such as a hydration capacity comparable to market standard TVP and a neutral taste.

In embodiments, the methods as taught herein may comprise extruding a mixture comprising faba bean protein concentrate, pea protein concentrate, and pea protein isolate. In embodiments, the methods as taught herein may comprise extruding a mixture comprising faba bean protein concentrate, pea protein concentrate, pea protein isolate, and calcium chloride (CaCl₂)).

In embodiments, the methods as taught herein may comprise extruding from 25% to 45% by weight of faba bean protein concentrate, from 15% to 40% by weight of pea protein concentrate, and from 25% to 50% by weight of pea protein isolate. In embodiments, the methods as taught herein may comprise extruding from 25% to 45% by weight of faba bean protein concentrate, from 15% to 40% by weight of pea protein concentrate, from 25% to 50% by weight of pea protein isolate, and from 0.5% by weight to 5% by weight of calcium chloride. In embodiments, the methods as taught herein may comprise extruding a mixture comprising from 16% to 30% by weight of faba bean protein and from 40% to 55% by weight of pea protein. Percentages (%) by weight are based on dry weight of the mixture.

In embodiments, the methods as taught herein may comprise extruding a mixture comprising faba bean protein, pea protein, and further pulse protein. The further pulse protein may be selected from chickpea protein, bean protein, cow pea protein, pigeon pea protein, lentil protein, Bambara bean protein, vetch protein, lupin protein, pulse nes protein, or a combination thereof. The further pulse protein may be selected from chickpea protein, bean protein, or a combination thereof.

In embodiments, the method may comprise extruding a mixture comprising faba bean protein and pea protein by kneading or mixing in an extruder.

In embodiments, the methods as taught herein may comprise extruding a mixture comprising faba bean protein and pea protein using an extruder such as a twin-screw extruder, in particular a co-rotating twin screw extruder. The extruder may comprise at least three zones, such as at least four zones or at least five zones, e.g. a zone comprising a supply opening, and further zones comprising heating. The extruder may comprise transport elements and kneading elements. The extruder may comprise a die. For instance, the extruder may comprise a die of about 5 cm. The extruder may comprise a cutter. The cutter refers to a rotating plate with 2 or 4-way blades. The extruder may comprise: (a) a zone comprising a supply opening, (b) at least three consecutive zones, such as at least four consecutive zones or at least five consecutive zones, and (c) a die, preferably wherein the consecutive zones are zones comprising a heating element or “heating zones”.

The term “consecutive zones” as used herein refers to a successive zones which are adjacent to (i.e., next to) each other, e.g. without being separated by other zones.

In embodiments, the methods as taught herein may comprise extruding a mixture comprising faba bean protein and pea protein in an extruder. The extrusion step may comprise subjecting the mixture to heat and/or pressure. In embodiments, the methods as taught herein may comprise extruding a mixture comprising faba bean protein and pea protein in an extruder, and allowing the mixture to exit the extruder via a die to form the TVP. As known in the art, when the mixture passes through the die, water will be evaporated, and the product will expand due to a pressure drop and/or temperature change.

As opposed to a method for preparing a high moisture meat analogue (HMMA) in which a long cooling die is used in order to gradually cool the product before it exits from the extruder, the method for preparing a textured vegetable protein (TVP) uses a shorter die, e.g. of about 5 cm, and hence when the product exists the extruder, the product expands in the air due to a sudden drop in temperature and/or pressure.

In embodiments, a TVP is an expanded or air expanded product (as opposed to a HMMA being a non-expanded product).

In embodiments, the extrusion temperature of a first consecutive heating zone may be between about 45 °C and about 55 °C, such as about between about 46 °C and about 50 °C In embodiments, the extrusion temperature of a second consecutive heating zone may be between about 91 °C and about 100 °C, such as between about 94 °C and about 98 °C In embodiments, the extrusion temperature of a third consecutive heating zone may be between about 101 °C and about 110 °C, such as between about 102 °C and about 106 °C

In embodiments, the temperature of the die may be about 145 °C to about 155 °C; preferably wherein the temperature of the die is about 148 °C to 152 °C; more preferably wherein the temperature of the die is about 150 °C This advantageously results in a TVP having satisfactory functionality and sensory properties for use in food applications.

In embodiments, the methods as taught herein may comprise drying the texturized vegetable protein; preferably wherein the drying temperature is about 30 °C to about 40 °C

In embodiments, the extruder screw speed may be from 1% to 10% or from 3% to 10%, in particular from 5 to 8%. Such speed provides better texture of the TVP.

In embodiments, the water feed rate may be from about 10 litre per hour (l/h) to about 50 l/h, such as from about 30 l/h to about 50 l/h, preferably from about 20 l/h to about 40 l/h. Such water feed rate provides better texture of the TVP.

In embodiments, the product feed rate may be from about 20 kg/h to about 55 kg/h, such as from about 25 kg/h to about 50 kg/h. Such feed rate provides better texture of the TVP.

In embodiments, the pressure may be from about 3 bar to about 6 bar, such as from about 4 bar to about 5 bar.

In embodiments, the torque may be from 40% to 60%, such as from 40% to 55%.

In embodiments, the methods as taught herein may comprise the step of cutting the TVP. In embodiments, the cutter speed may be from 1% to 10%, or from 3% to 10%, such as from about 5% to 8%.

The present application also provides aspects and embodiments as set forth in the following statements:

Statement 1. A texturized vegetable protein (TVP) comprising faba bean protein and pea protein, wherein the TVP comprises at least 60% by weight of faba bean protein and pea protein, with % by weight based on dry weight of the TVP, and wherein the TVP has a hydration capacity above 3.0 g water/g of the TVP.

Statement 2. The texturized vegetable protein according to statement 1, wherein the texturized vegetable protein has a hydration capacity of from 3.2 to 5.0 g water/g of the texturized vegetable protein; preferably a hydration capacity of from 3.5 to 4.5 g water/g of the texturized vegetable protein.

Statement 1′. A texturized vegetable protein (TVP) comprising faba bean protein and pea protein, wherein the TVP comprises at least 60% by weight of faba bean protein and pea protein, with % by weight based on dry weight of the TVP, and wherein the TVP has a hydration capacity of at least 4.0 g water/g of the TVP after a hydration time of 15 minutes.

Statement 2′. The texturized vegetable protein according to statement 1′, wherein the texturized vegetable protein has a hydration capacity of from 4.0 to 5.0 g water/g of the texturized vegetable protein after a hydration time of 15 minutes; preferably a hydration capacity of from 4.0 to 4.5 g water/g of the texturized vegetable protein after a hydration time of 15 minutes.

Statement 3. The texturized vegetable protein according to statement 1 or 2, 1′ or 2′, wherein the texturized vegetable protein comprises further pulse protein selected from chickpea protein, bean protein, cow pea protein, pigeon pea protein, lentil protein, Bambara bean protein, vetch protein, lupin protein, pulse nes protein, or a combination thereof; preferably wherein the texturized vegetable protein comprises further pulse protein selected from chickpea protein, bean protein, or a combination thereof.

Statement 4. The texturized vegetable protein according to any one of statements 1 to 3, 1′ or 2′, wherein the texturized vegetable protein comprises at least 65% by weight of faba bean protein and pea protein, with % by weight based on dry weight of the TVP.

Statement 5. The texturized vegetable protein according to any one of statements 1 to 4, 1′ or 2′, wherein the texturized vegetable protein has a density of 0.030 kg/l to 0.100 kg/l; preferably wherein the texturized vegetable protein has a density of 0.050 kg/l to 0.080 kg/l.

Statement 6. The texturized vegetable protein according to any one of statements 1 to 5, 1′ or 2′, wherein the texturized vegetable protein has a solids content of at least 88% by weight, with % by weight based on total weight of the TVP; preferably wherein the texturized vegetable protein has a solids content of at least 90% by weight, with % by weight based on total weight of the TVP.

Statement 7. The texturized vegetable protein according to any one of statements 1 to 6, 1′ or 2′, wherein the texturized vegetable protein comprises calcium chloride (CaCl₂)); preferably wherein the texturized vegetable protein comprises from 0.5% to 5% by weight of calcium chloride, with % by weight based on dry weight of the TVP.

Statement 8. The texturized vegetable protein according to any one of statements 1 to 7, 1′ or 2′, wherein the texturized vegetable protein comprises:
particles having a shape of chunks, granules, or slices;
particles having a size of at most 5.0 cm, such as at most 4.0 cm, at most 3.0 cm, or at most 2.5 cm; preferably wherein the texturized vegetable protein comprises particles having a size of from 0.5 cm to 5.0 cm, such as from 1.0 cm to 4.0 cm or from 1.5 cm to 3.5 cm.

Statement 9. The texturized vegetable protein according to any one of statements 1 to 8, 1′ or 2′, wherein the texturized vegetable protein is prepared by extruding a mixture comprising faba bean protein concentrate, pea protein concentrate, pea protein isolate, and optionally calcium chloride (CaCl₂)).

Statement 10. The texturized vegetable protein according to any one of statements 1 to 9, 1′ or 2′, wherein the texturized vegetable protein is prepared by extruding a mixture comprising from 25% to 45% by weight of faba bean protein concentrate, from 15% to 40% by weight of pea protein concentrate, from 25% to 50% by weight of pea protein isolate, and optionally from 0.5% to 5% by weight of calcium chloride, with % by weight based on dry weight of the mixture.

Statement 11. The texturized vegetable protein according to any one of statements 1 to 10, 1′ or 2′, wherein the texturized vegetable protein comprises from 16% to 30% by weight of faba bean protein and from 40% to 55% by weight of pea protein, with % by weight based on dry weight of the TVP.

Statement 12. An edible composition comprising the texturized vegetable protein as defined in any one of statements 1 to 11, 1′ or 2′.

Statement 13. The edible composition according to statement 12, wherein the edible composition is a food or feed product; preferably wherein the edible composition is a vegetarian product, vegan product, meat product, dairy product, non-dairy product, confectionery product, beverage, food supplement, nutritional product destined to weight control, sports food, medical food, food for elderly, or bakery food product.

Statement 14. Use of the texturized vegetable protein as defined in any one of statements 1 to 11, 1′ or 2′, in a food product or a feed product; preferably in vegetarian products, vegan products, meat products, dairy products, non-dairy products, confectionery products, beverages, food supplements, nutritional products destined to weight control, sports food, medical food, food for elderly, or bakery food products.

Statement 15. The use according to statement 14, as a meat analogue or a meat extender.

The above aspects and embodiments are further supported by the following non-limiting examples.

### EXAMPLES

### Materials and Methods

### Determination of Protein Content by the Dumas Method

The apparatus (Leco FP2000) was calibrated with EDTA marketed by Leco under reference 502092. The Quantities of EDTA weighed for the realization of the calibration ranged from 0.08 g to 0.50 g (0.08 g, 0.15 g, 0.25 g, 0.35 g, 0.40 g, 0.50 g). 0.3 g to 1 g of sample was weighed on a precision balance (Sartorius BP61 S, capacity 61 g, sensitivity 0.1 mg) and placed into a ceramic boat. The ceramic boat was automatically placed in an oven at 1200 °C, wherein the sample was burnt in a combustion tube by pyrolysis under controlled oxygen flow. Nitrogen compounds are converted to N₂ and NOx while other volatile decomposition compounds are retained through adsorbent filters and series of purification regents. All nitrogen compounds are reduced to molecular N, which is quantitatively determined by a thermal conductivity detector. The Nitrogen content was then calculated by a microprocessor.

Results are expressed as a percentage of protein as follows:
% Nitrogen=g of Nitrogen per 100 g of sample
% protein=% Nitrogen×6.25

### Density

The density was measured by pouring the TVP in a 500 ml glass and the mass (m) was noted in g.
Volume (Vav) was recorded in ml.
Density was calculated as follows: density=m/Vav, wherein
m: mass in g
Vav: volume in ml.

### Hydration Rate

In an 800 ml beaker, 400 ml of water was added with 15 g of TVP. The mixture was left for a hydration time of 15 minutes. The TVP was then collected using a sieve. The TVP was weighted after hydration, noted P. The hydration rate was calculated as: (P-15)/15.

### Dry Matter or Solids Content Determination

Total dry matter or solids content was determined gravimetrically as residue remaining after drying. Moisture was evaporated from sample by oven drying.

5 g of sample were weighed in a dry aluminium dish previously weighed (precision balance Ohaus, capacity 410 g, sensitivity 0.001 g). The sample was placed in an oven at 103 °C until the residual weight remained constant (at least 24 h). Sample was cooled in a desiccator for 1 h and then immediately weighed. Results are expressed in % (g of dry matter per 100 g of sample).
Dry matter (%)=(m3−m1)/(m2−m1)×100
m1=weight of the dry aluminium dish (in g)
m2=weight of the aluminium dish with the sample before drying (in g)
m3=weight of the aluminium dish with the sample after drying (in g)

### Example 1: Production of Texturized Vegetable Protein According to an Embodiment of the Invention Comprising a Mixture of Pea Protein and Faba Bean Protein

A texturized vegetable proteins (TVP) according to an embodiment of the invention (i.e., faba bean/pea TVP A1) was prepared by extrusion.

The used material is a co-rotating twin screw extruder. The extruder contained four zones (a zone comprising a supply opening and three consecutive heating zones) and a die.

### Control Parameters During Processing

Control parameters during the production process were as provided in Table 1.

TABLE 1
Control parameters during the production process of
faba bean/pea TVP A1 illustrating the invention

| | |
|---|---|
| Screw speed (%) | 7 |
| Cutter speed (%) | 7 |
| Tool T (°C) B | 50/51 |
| Tool T (°C) C | 50/75 |
| Tool T (°C) D | 50/85 |
| Liquid 1 (water) (l/h) | 42 |
| Flow rate (%) | 30 |
| Pressure (bar) | 5 |
| Torque (%) | 50 |
| Outlet T (°C) | 150 |
| Barrel T (°C) B | 47 |
| Barrel T (°C) C | 96 |
| Barrel T (°C) D | 104 |
| Dryer I/II (°C) | 35/35 |

The composition of the faba bean/pea TVP A1 was as follows (with % by weight based on the dry weight of the TVP):
30% by weight of faba bean protein concentrate HerbaPRO FB65 (Herba Ingredients BV, The Netherlands),
35% by weight of pea protein concentrate (AMN pea protein concentrate, AM nutrition), and
35% by weight of pea protein isolate (PISANE™ M9, Cosucra).

The faba bean/pea TVP A1 was prepared as chunks.

The faba bean concentrate as used in the faba bean/pea TVP A1 according to an embodiment of the invention comprised 60-70% by weight of protein. The pea protein concentrate as used in the faba bean/pea TVP A1 comprised 56±3% by weight of protein. The pea protein isolate as used in the faba bean/pea TVP A1 comprised 86±2% by weight of protein.

The faba bean protein content, pea protein content, and ratio of the faba bean/pea TVP A1 according to an embodiment of the invention is provided in Table 2.

TABLE 2
Faba bean protein content, pea protein content, and
ratio pea protein/faba bean protein of faba bean/pea
TVP A1 according to an embodiment of the invention

| | Faba bean | | Ratio pea |
|---|---|---|---|
| | protein | Pea protein | protein/ |
| | content (%, | content (%, | faba |
| Recipe | calculated) | calculated) | protein |
| chunks | 18-21 | 47-51 | 2.24-2.83 |

### Comparative Example 1: Production of Comparative TVP Comprising a Mixture of Pea Protein and Faba Bean Protein

An exemplary texturized vegetable protein (TVP) comprising pea protein and faba bean protein according to the prior art (i.e., comparative faba bean/pea TVP B1) was produced in a co-rotating twin screw extruder type BC45 (Clextral). The setup (screw configuration) of the extruder was as follows:

| Zone 1 | | Zone 2 | | Zone 3 | | Zone 4 | | | | Zone 5 | | | |
|---|---|---|---|---|---|---|---|---|---|---|---|---|---|
| C2F | C1F | C1F | C1F | C1F | C1F | C1F | Kn BiL | Kn BiL | Kn BiL | C1F | C1F | C1F | C1F |
| 100/50 | 100/50 | 100/50 | 100/33 | 100/25 | 50/25 | 50/25 | 50/25 | 50/25 | 50/25 | 50/25 | 50/25 | 50/25 | 50/25 |

Powder and water were added to zone 1.

The used screw elements were defined as follows: C2F 100/50 (transport element): 2 step displacement, Length 100 mm, Pitch: distance of displacement within a complete rotation 50 mm; C1F 100/50 (transport element): 1 step displacement, Length of screw 100 mm, Pitch: distance of displacement within a complete rotation 50 mm; C1F 100/33 (transport element): 1 step displacement, Length of screw 100 mm, Pitch: distance of displacement within a complete rotation 33 mm; C1F 100/25 (transport element): 1 step displacement, Length of screw 100 mm, Pitch: distance of displacement within a complete rotation 25 mm; C1F 50/25 (transport element): 1 step displacement, Length of screw 50 mm, Pitch: distance of displacement within a complete rotation 25 mm; Kn BiL 50/25 (Kneading element): Length of screw 50 mm. Due to this kneading element, the product was pressed under pressure between the lobes by the pre-placed transport elements. Temperature range: 1st module/zone (no heating): only supply opening; the 4 following modules: Heating zone (T1): 20-50 °C; Heating zone (T2): 20-70 °C; Heating zone (T3): 20-90 °C; Heating zone (T4): 20-150 °C The extrusion temperatures were set to (from inlet to die): 1st zone: no heating; T1:40 °C; T2:50 °C; T3:70 °C; T4:110 °C; die: 130 °C

Other parameters:
Extruder screw speed: 50-400 rpm
Water Feed rate: 0-60 l/h
Product Feed Rate: 20-55 kg/h
Cutter speed: 0-3000 rpm

The parameters including screw speed (rpm), feed rate (kg/h), water feed rate (L/hour), cutter speed (rpm), an injection pump (L/h) were adapted to obtain the resulting TVP, i.e. comparative faba bean/pea TVP B1.

The composition of the comparative faba bean/pea TVP B1 was: 30% by weight of faba bean protein concentrate (HerbaPRO FB65, Herba Ingredients BV, The Netherlands); 34% by weight of pea protein concentrate (AMN pea protein concentrate, AM nutrition AS, Norway); 35% by weight of pea protein isolate (PISANE™ M9, Cosucra Groupe Warcoing, Belgium); and 1% by weight of CaCl₂) (NutriCal, calcium carbonate heavy, batch number 07/2020).

An exemplary texturized vegetable protein comprising pea protein according to the prior art, i.e. comparative pea TVP C1, was produced by extrusion with the same method as described in Example 1 for faba bean/pea protein TVP A1. The composition of the comparative pea TVP C1 was: 60% by weight of pea protein concentrate (AMN pea protein concentrate, AM nutrition AS, Norway); and 40% by weight of pea protein isolate (PISANE™ M9, Cosucra Groupe Warcoing, Belgium). The comparative pea TVP C1 was prepared as chunks.

### Example 2: Analysis of Faba Bean/Pea TVP According to an Embodiment of the Invention

In the following example, the faba bean/pea TVP A1 illustrating the invention was analysed for properties such as density, size, hydration capacity, and sensory analysis. Comparison was made to comparative faba bean/pea TVP B1 and comparative pea TVP C1.

### Characterization and Results

### Chemical Analysis

The solids content (in weight % based on total weight of the TVP) and protein content (in weight % based on dry weight of the TVP) of faba bean/pea TVP A1 illustrating the invention and comparative TVPs was determined as described herein. Results are provided in Table 3.

TABLE 3
Chemical analysis of faba bean/pea TVP A1 illustrating
the invention and comparative TVPs

| TVP | Solids (%) | Protein content (%) |
|---|---|---|
| faba bean/pea TVP A1 | 90.0 | 60.6 |
| comparative faba bean/pea TVP B1 | 90.5 | 68.5 |
| comparative pea TVP C1 | 90.8 | 68.1 |

The solids content of faba bean/pea TVP A1 illustrating the invention was similar to the solids content of comparative faba bean/pea TVP B1 and of comparative pea TVP C1.

The protein content of faba bean/pea TVP A1 of 60.6% (based on dry matter) was slightly lower compared to comparative faba bean/pea TVP B1 and comparative pea TVP C1.

### Physical Characteristics

The texture including density and size of faba bean/pea TVP A1 and comparative TVPs was determined. Results are provided in Table 4. All TVPs had the shape of chunks.

TABLE 4
Physical characteristics of faba bean/pea
TVP A1 and comparative TVPs

| | Density | Length | Width |
|---|---|---|---|
| TVP | (kg/l) | (mm) | (mm) |
| faba bean/pea TVP A1 | 0.059 | 29.1 | 17.1 |
| comparative faba | 0.104 | 21.7 | 11.8 |
| bean/pea TVP B1 | | | |
| comparative pea TVP C1 | 0.074 | 22.4 | 17.9 |

The density of faba bean/pea TVP A1 illustrating the invention was lower than the density of comparative pea TVP C1 and than the density of the comparative faba bean/pea TVP B1.

The size of faba bean/pea TVP A1 illustrating the invention was larger than the size of comparative faba bean/pea TVP B1. The size of the faba bean/pea TVP A1 was comparable to the size of comparative pea TVP C1.

The faba bean/pea TVP A1 gave good results in terms of texture which was comparable to comparative pea TVPs currently considered as the market standard.

### Functional Properties

The hydration capacity of faba bean/pea TVP A1 illustrating the invention and pea TVP was determined. Results are provided in Table 5.

TABLE 5
Hydration capacity of faba bean/pea
TVP A1 and comparative TVPs

| | Hydration capacity (after |
|---|---|
| TVP | 15 min) (g water/g TVP) |
| faba bean/pea TVP A1 | 4.3 |
| comparative faba bean/pea TVP B1 | 3.0 |
| comparative pea TVP C1 | 3.9 |

The hydration capacity of the faba bean/pea TVP A1 illustrating the invention was higher than the hydration capacity of comparative faba bean/pea TVP B1. The higher hydration capacity of the faba bean/pea TVP illustrating the invention advantageously allows good functionality in different food applications. The hydration capacity of the faba bean/pea TVP A1 was comparable to the hydration capacity of comparative pea TVP C1.

The faba bean/pea TVP A1 thus gave good results in terms of functionality which was comparable to comparative pea TVP C1.

### Sensory Analysis

A sensory analysis was performed for faba bean/pea TVP A1 according to an embodiment of the invention and for pea TVP C1. The sensory analysis was performed after 10 minutes of water absorption or after 10 minutes of water absorption followed by 45 s at 1000 W in a microwave. The results are provided in Table 6.

TABLE 6
Results of sensory analysis for faba bean/pea
TVP A1 and comparative pea TVP C1

| TVP | 10 min | 10 min + microwave |
|---|---|---|
| faba bean/ | Good bite, not bitter, | Softer, less bite, |
| pea TVP A1 | neutral, less pea | more watery, no off note |
| comparative | Pea taste, no off-note, | More bite, pea taste, |
| pea TVP C1 | good bite, not bitter, | no off-note |
| | neutral | |

The faba bean/pea texturized vegetable protein A1 illustrating the invention provided good results in term of sensory analysis which were better than the comparative pea TVP having pea taste. Overall, the faba bean/pea TVP A1 gave satisfying results in terms of taste which was less pronounced as compared to comparative pea TVP.

### CONCLUSION

The texturized vegetable protein comprising pea protein and faba bean protein according to the invention gave good results in terms of texture and taste for food applications. Due to the hydration capacity which was comparable to comparative pea TVPs currently considered as the market standard, the present texturized vegetable proteins have high functionality in many food applications. Moreover, the present texturized vegetable proteins have a neutral taste and provide good results in term of sensory analysis, thereby allowing broad applicability in food applications such as to replace meat. Furthermore, the present texturized vegetable proteins are high in protein, free of animal-based protein, free of gluten, high in essential amino acids, and suitable for vegetarian and vegan products.

1. A texturized vegetable protein (TVP) comprising faba bean protein and pea protein, wherein the TVP comprises at least 60% by weight of faba bean protein and pea protein, with % by weight based on dry weight of the TVP, and wherein the TVP has a hydration capacity of at least 4.0 g water/g of the TVP after a hydration time of 15 minutes.

2. The texturized vegetable protein according to claim 1, wherein the texturized vegetable protein has a hydration capacity of from 4.0 to 5.0 g water/g of the texturized vegetable protein after a hydration time of 15 minutes.

3. The texturized vegetable protein according to claim 1, wherein the texturized vegetable protein comprises further pulse protein selected from the group consisting of chickpea protein, bean protein, cow pea protein, pigeon pea protein, lentil protein, Bambara bean protein, vetch protein, lupin protein, pulse nes protein, and a combination thereof.

4. The texturized vegetable protein according to claim 1, wherein the texturized vegetable protein comprises at least 65% by weight of faba bean protein and pea protein, with % by weight based on dry weight of the TVP.

5. The texturized vegetable protein according to claim 1, wherein the texturized vegetable protein has a density of 0.030 kg/l to 0.100 kg/l.

6. The texturized vegetable protein according to claim 1, wherein the texturized vegetable protein has a solids content of at least 88% by weight, with % by weight based on total weight of the TVP.

7. The texturized vegetable protein according to claim 1, wherein the texturized vegetable protein comprises calcium chloride (CaCl₂).

8. The texturized vegetable protein according to claim 1, wherein the texturized vegetable protein comprises:
particles having a shape of chunks, granules, or slices;
particles having a size.

9. The texturized vegetable protein according to claim 1, wherein the texturized vegetable protein is prepared by extruding a mixture comprising faba bean protein concentrate, pea protein concentrate, pea protein isolate, and optionally calcium chloride (CaCl₂).

10. The texturized vegetable protein according to claim 1, wherein the texturized vegetable protein is prepared by extruding a mixture comprising from 25% to 45% by weight of faba bean protein concentrate, from 15% to 40% by weight of pea protein concentrate, from 25% to 50% by weight of pea protein isolate, and optionally from 0.5% to 5% by weight of calcium chloride, with % by weight based on dry weight of the mixture.

11. The texturized vegetable protein according to claim 1, wherein the texturized vegetable protein comprises from 16% to 30% by weight of faba bean protein and from 40% to 55% by weight of pea protein, with % by weight based on dry weight of the TVP.

12. An edible composition comprising the texturized vegetable protein as defined in claim 1.

13. The edible composition according to claim 12, wherein the edible composition is a food or feed product.

14. (canceled)

15. The edible composition according to claim 12, wherein the edible composition is a meat analogue or a meat extender.

16. The texturized vegetable protein according to claim 2, wherein the texturized vegetable protein has a hydration capacity of from 4.0 to 4.5 g water/g of the texturized vegetable protein after a hydration time of 15 minutes.

17. The texturized vegetable protein according to claim 5, wherein the texturized vegetable protein has a density of 0.050 kg/l to 0.080 kg/l.

18. The texturized vegetable protein according to claim 6, wherein the texturized vegetable protein has a solids content of at least 90% by weight, with % by weight based on total weight of the TVP.

19. The texturized vegetable protein according to claim 7, wherein the texturized vegetable protein comprises from 0.5% to 5% by weight of calcium chloride (CaCl₂)), with % by weight based on dry weight of the TVP.

20. The texturized vegetable protein according to claim 8, wherein the texturized vegetable protein comprises particles having a size from 1.0 cm to 4.0 cm.

21. The edible composition according to claim 12, wherein the edible composition is a vegetarian product, vegan product, meat product, dairy product, non-dairy product, confectionery product, beverage, food supplement, nutritional product destined to weight control, sports food, medical food, food for elderly, or bakery food product.
